(19) United States
(12) Patent Application Publication
(10) Pub. No.: US 2025/0384621 A1
(43) Pub. Date: Dec. 18, 2025

(54) DIFFERENTIAL DIRECT VISIBILITY OF POINT CLOUDS

(71) Applicant: Technion Research & Development Foundation Limited, Haifa (IL)

(72) Inventors: Ayellet TAL, Haifa (IL); Sagi KATZ, Haifa (IL)

(73) Assignee: Technion Research & Development Foundation Limited, Haifa (IL)

(21) Appl. No.: 19/241,678

(22) Filed: Jun. 18, 2025

Related U.S. Application Data
(60) Provisional application No. 63/661,148, filed on Jun. 18, 2024.

(51) Int. Cl. G06T 15/40; G06T 17/00

(52) U.S. Cl. CPC G06T 15/40; G06T 17/00

(57) ABSTRACT

A method and system are provided for determining visibility of points in 3D point clouds without requiring surface reconstruction. The method applies a differentiable radial transformation to transform points in a manner that maps visible points to extreme positions, followed by a novel differentiable computation to identify these extreme points. Unlike previous approaches, the method's end-to-end differentiability enables direct optimization of viewpoint positions and integration with machine learning systems while maintaining theoretical correctness guarantees. The method is computationally efficient through parallel implementation and robust to varying point densities and noise. Applications include optimal viewpoint selection, visibility-based path planning, and 3D scene understanding tasks that benefit from differentiable visibility determination.

### RELATED APPLICATION(S)

This application claims the benefit of priority of U.S. Provisional Patent Application No. 63/661,148 filed on Jun. 18, 2024, the contents of which are all incorporated by reference as if fully set forth herein in their entirety.

### FIELD AND BACKGROUND OF THE INVENTION

The present invention, optionally, relates to point cloud viewpoint optimization and, more particularly, but not exclusively, to approximately determining visibility of points in a point cloud in a differentiable manner.

An important problem in computational geometry is determining the visibility of an object with a sufficiently high resolution. For instance, if it is known that some surfaces of an object are not visible from a given point of view, a rendering engine may skip processing these surfaces and conserve substantial computational resources.

Another common application is determining an optimal viewpoint for a visualization program to provide a user with the most informative viewing angle for an object. A common approach to solving this problem is sampling a sufficiently large number of points on the surface of an object and determining the ratio of the number of points visible from a given viewpoint to the total number of sampled points, and using this metric to select a viewpoint among several discrete options. Other applications where point visibility may be applied include shadow estimation, normal approximation, path planning, action recognition and more.

However, existing methods either depend on reconstruction of surfaces, which requires additional information such as normals for each point in the point cloud and involves intense computations, or are unsuitable for utilization within optimization processes or learning models due to the lack of differentiability of their mathematical foundation.

### SUMMARY OF THE INVENTION

According to an aspect of some embodiments of the present invention, there is provided a method for determining the visibility of a point cloud respective to a viewpoint, the method is effected by: receiving a viewpoint and a point cloud including a plurality of points; computing, for one or more points in the point cloud, respective transformed points using a radial transformation function, thereby generating a plurality of transformed points; differentiably computing, for the plurality of transformed points, a convex hull approximation; and outputting, for each of the one or more points in the point cloud and the viewpoint, a visibility indicator.

In some embodiments, the radial transformation function maintains direction from the viewpoint to a point in the point cloud as direction from the viewpoint to a respective transformed point, and wherein the radial transformation function determines distance from the viewpoint to a transformed point based at least in part on distance from the viewpoint to a respective point in the point cloud.

In some embodiments, the radial transformation function is monotonically decreasing.

In some embodiments, the radial transformation function includes a linear inversion kernel.

In some embodiments, the radial transformation function includes an exponential inversion kernel.

In some embodiments, differentiably computing a convex hull approximation includes: computing, for the plurality of transformed points, a plurality of respective vector projections from the viewpoint to a transformed point on a vector from the viewpoint to a first transformed point; determining a transformed point maximizing vector projection on the vector from the viewpoint to the first transformed point; and outputting, for the first transformed point, a positive indicator if the first transformed point maximizes vector projection on the vector from the viewpoint to the first transformed point, and a negative indicator otherwise.

In some embodiments, determining a transformed point maximizing vector projection on the vector from the viewpoint to the first transformed point includes: determining, using a predetermined normalization function, a top-k projection length value; and normalizing the plurality of vector projections by the top-k projection length value.

In some embodiments, determining the top projection length value at position k is performed approximately in a differentiable manner.

In some embodiments, normalizing a considered projection length utilizing a predetermined normalization function partially includes computing the output of exponential linear unit.

In some embodiments, computing a convex hull approximation further includes: determining a center of mass of the plurality of transformed points; selecting an auxiliary point on a line connecting the center of mass of the plurality of transformed points and the viewpoint; computing, for the plurality of transformed points, a respective plurality of vector projections from the auxiliary point to a transformed point on a vector from the auxiliary point to a first transformed point; determining a transformed point maximizing vector projection on the vector from the auxiliary point to the first transformed point; outputting, for the first transformed point, a positive indicator if the first transformed point maximizes at least one of (i) vector projection on the vector from the viewpoint to the first transformed point or (ii) vector projection on the vector from the auxiliary point to the first transformed point, and a negative indicator otherwise.

According to an aspect of some embodiments of the present invention, there is provided a method for determining an optimal viewpoint placement for a point cloud, the method is effected by: iteratively performing an optimization process to compute an optimal viewpoint position based on an initial viewpoint position one or more times, the optimization process including: calculating a visibility score gradient with respect to a viewpoint position; adjusting the viewpoint position in a one of (i) direction of the visibility score gradient, thereby increasing the visibility score, or (ii) in the direction opposite to the visibility score gradient, thereby decreasing the visibility score; and responsive to meeting a predetermined local convergence criterion, terminating the optimization process, thereby generating the optimal viewpoint position optimizing a total visibility score.

In some embodiments, the method further includes: performing one of (i) receiving or (ii) generating a plurality of initial viewpoint positions; for each initial viewpoint position in the plurality of initial viewpoint positions, iteratively performing the optimization process to compute a respective optimal viewpoint position one or more times, thereby generating a plurality of optimal viewpoint positions and a plurality of total visibility scores; responsive to meeting a global convergence criterion, outputting a globally optimal viewpoint position based at least on the plurality of total visibility scores, wherein the optimization process further includes, responsive to meeting the predetermined convergence criterion, storing the optimal viewpoint position and the respective total visibility score.

According to an aspect of some embodiments of the present invention, there is provided a computer system, including: a processor configured to execute stored executable instructions; and a non-transitory computer readable medium storing executable instructions that, when executed by a processor, cause the computer system to perform the following: receive a viewpoint and a point cloud including a plurality of points; compute, for one or more points in the point cloud, respective transformed points using a radial transformation function, thereby generating a plurality of transformed points; differentiably compute, for the plurality of transformed points, a convex hull approximation; and output, for each of the one or more points in the point cloud and the viewpoint, a visibility indicator.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 an illustration of a point cloud of a human head model, according to some embodiments of the invention;

FIG. 2 is a flowchart illustrating a general workflow of the method, according to some embodiments of the invention;

FIG. 3 is an illustration for determining visibility of points in an example 2D contour, according to some embodiments of the invention;

FIG. 4 is a diagram illustrating the process of computing a convex hull approximation in a differentiable manner, according to some embodiments of the invention;

FIG. 5 is an illustration of the accuracy of the method on a sample input, according to some embodiments of the invention;

FIG. 6 is an illustration of the accuracy of the method as a function of a parameter δ for various noise levels in the original point cloud, according to some embodiments of the invention;

FIG. 7 is an illustration of the accuracy of the method as a function of a parameter a for various sizes of the point cloud, according to some embodiments of the invention;

FIG. 8 is an illustration of the accuracy of the method as a function of a parameter γ for various sizes of the point cloud, according to some embodiments of the invention; and

FIG. 9 is an illustration of viewpoint optimization, according to some embodiments of the invention.

### DESCRIPTION OF SPECIFIC EMBODIMENTS OF THE INVENTION

The present invention, optionally, relates to point cloud viewpoint optimization and, more particularly, but not exclusively, to approximately determining visibility of points in a point cloud in a differentiable manner.

As used herein, the terms “point cloud”, “set of points” and “point set” may be used interchangeably.

Viewpoint selection is crucial for effectively visualizing 3D objects to enhance understanding and recognition. Various metrics exist for determining the optimality of a viewpoint. One such metric determines optimal viewpoints by maximizing visibility of key features of 3D objects.

To determine a visibility metric of a viewpoint for a 3D model, it is necessary to determine the visibility from the viewpoint of a point cloud comprising individual points sampled from a continuous surface of the 3D model. Determining the exact visibility of all sample points is a computationally challenging problem, requiring introduction of approximation methods.

While existing approximation methods exist for solving this problem, they are unsuitable for utilization within viewpoint optimization processes or learning models due to their lack of differentiability. For example, the Hidden Point Removal (HPR) method comprises construction of a convex hull with methods such as QuickHull, which lack differentiability and therefore prevent the HPR method from efficient utilization in viewpoint optimization tasks.

According to the present method, the convex-hull approximation is generated by testing every sampled point independently to decide whether it is extreme in at least one viewing direction, wherein each test follows the same short branch-free sequence of operations. As processing a point does not depend on data produced by processing any other points, identical evaluations can be distributed across multiple GPU threads without requiring synchronization, in contrast to conventional methods such as QuickHull which maintain and update a list of facets, use data-dependent recursion and access scattered memory addresses, creating inter-point dependencies and control-flow divergence that prevent efficient GPU mapping.

Furthermore, according to the present method, for every sampled point, extremity is assessed by employing only elementary, continuously differentiable operations such as vector and scalar arithmetic, dot product, and reduction-to-maximum operations. Any subsequent thresholding that converts the continuous extremity score into a binary visibility flag is performed after gradient evaluation and therefore does not interrupt back-propagation. As a result, a higher-level optimization process may propagate gradients from the final visibility scores directly to the viewpoint parameters and/or point coordinates, enabling the optimization process to refine viewpoint pose in an end-to-end manner.

The present method therefore enables efficient automatic optimization for determining optimal viewpoints by maximizing visibility of key model features while maintaining computational efficiency and enabling parallelization. Practically, this enables users to quickly perceive and evaluate 3D models without manual viewpoint adjustment.

According to one of the methods disclosed in the present application, visibility of points in a point cloud is determined without requiring surface reconstruction, enabling efficient viewpoint optimization and integration with deep learning pipelines.

The method described hereinbelow enables differentiable computation of point visibility that maintains theoretical correctness guarantees while being suitable for optimization.

The method described hereinbelow is particularly useful for optimal viewpoint selection, visibility-based path planning, normal estimation, document enhancement, action recognition, and localization applications.

The present invention offers several notable advantages and improvements including: direct visibility determination without surface reconstruction, differentiable computation enabling gradient-based optimization, theoretical guarantees of correctness in the limit, efficient parallel implementation; and robustness to varying point sampling densities and noise.

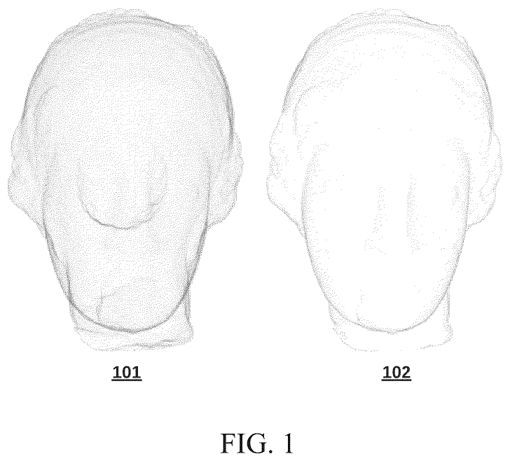

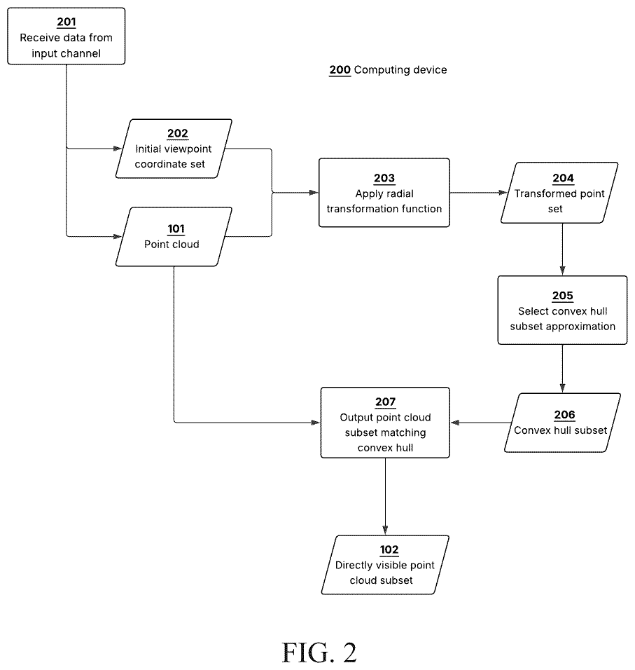

For purposes of better understanding some embodiments of the present invention, as illustrated in FIGS. 2-9 of the drawings, reference is first made to a point cloud of a human head model as illustrated in FIG. 1. According to the background of the invention, a point cloud 101, which constitutes a sampling of a continuous surface, comprises a set of 3D positions in space. When viewed from a given viewpoint, points in the point cloud 101 do not inherently occlude each other unless they coincidentally align along the same viewing ray. However, to determine which points would be visible if the underlying continuous surface existed, a method for determining visibility of a point cloud must identify a subset of points 102 that corresponds to the genuinely visible surface points. While precise visibility determination is possible through surface reconstruction, such reconstruction is computationally complex and often requires additional information like surface normals. The present invention provides a practical method for determining point visibility with acceptable precision directly from the point cloud 101, without performing surface reconstruction. Furthermore, the method's differentiable nature enables seamless integration with optimization processes and deep learning pipelines.

The method may be implemented on a computing system including at least one processor and memory, where the processor is configured to perform parallel computation of visibility scores for multiple points simultaneously. The system may include a GPU for accelerated computation of point transformations and visibility determination. Memory requirements scale linearly with the number of points in the input point cloud.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Optionally, the method for approximately determining visibility of points in a point set P [symbol] , wherein D is the space dimensionality, from a viewpoint C comprises a point transformation step and an approximated convex hull computation step, wherein each step is performed using a differential procedure. The approximated approach relaxes the need for utilizing an accurate non-differentiable convex hull construction algorithm.

As used herein, the term “extreme point” means a point p′ in a point set P 101, wherein the point p′ is the farthest point in at least one direction relative to all the other points in the point set P 101.

As used herein, the term “convex hull” means of a point set P 101, or a point cloud, means the smallest convex set encompassing the point set P 101.

Optionally, the point transformation step comprises transforming the point set P 101 into a dual space using a kernel function f: [symbol] → [symbol] , subject to conditions such that (i) points that were initially closer to the viewpoint are moved farther away, and (ii) mildly concave regions are changed into convex regions.

Optionally, the kernel function f(d) comprises an invertible 1-dimensional continuous kernel function, possessing a parameter γ, operating on a distance d>0 of a point pᵢ from a viewpoint C, and generating an updated distance, wherein ∀pᵢ∈P 101 for i∈[1, n].

Optionally, the kernel function f(d) is monotonically decreasing: f′(d)<0.

Optionally, the kernel function f(d) maintains orientation of the points ∀pᵢ∈P 101 relative to the viewpoint C is maintained: f(d)>0.

Optionally, the kernel function f(d) satisfies a condition such that for any ∀d₁, ∀d₂∈ [symbol] s·t·d₁>d₂ and for any 0<∀∈<1 there exists a value

$$∃ γ = Γ , s . t . 1 > \frac{f ( {d}_{1} )}{f ( {d}_{2} )} > 1 - ϵ .$$

Optionally, the kernel function f(d) comprises a linear inversion kernel: f(d)=δ−d, wherein

$$γ \geq {max}_{{p}_{i} ∈ P} ( ‖ {p}_{i} ‖ ) .$$

A linear inversion kernel preserves the direction from the viewpoint C to a point pᵢ and determines the distance from the viewpoint C to the transformed point as the result of a combination of linear operators acting upon the scalar distance d from the viewpoint C to the point pᵢ in the point cloud P 101.

Optionally, the kernel function f(d) comprises an exponential inversion kernel: f(d)=d^{δ}, wherein δ<0. An exponential inversion kernel preserves the direction from the viewpoint C to a point pᵢ and determines the distance from the viewpoint C to the transformed point as the result of exponentiation of the scalar distance d from the viewpoint C to the point pᵢ in the point cloud P 101.

Optionally, transforming the point set P 101 into a dual space comprises a radial transformation F_{f}: [symbol] → [symbol] :

$${F}_{f} ( {p}_{i} , C ) = C + \frac{{p}_{i} - C}{‖ {p}_{i} - C ‖} {f}_{γ} ( ‖ {p}_{i} - C ‖ ) if {p}_{i} \neq C$$

$${F}_{f} ( {p}_{i} , C ) = 0 if {p}_{i} = C .$$

Optionally, the method comprises applying an approximated convex hull computation to the transformed point set and the viewpoint C: {F_{f}(pᵢ, C)|∀pᵢ∈P}∪C.

Optionally, the input point set P 101 is resampled to a desired number of points n based on one of (i) random sampling, or (ii) a predetermined heuristic, thereby enabling a control of computational costs of applying the method to the input point set P 101.

Optionally, the size of the sampled subset is determined based on one of (i) a fixed percentage of the original point cloud size (typically 10-20%), (ii) a target absolute number of points based on computational resources; and (iii) an adaptive criterion that maintains sampling density proportional to local geometric complexity.

Optionally, the method adjusts sampling parameters automatically to maintain accuracy above a predetermined threshold.

Reference is now made to FIG. 2, illustrating the general workflow of the proposed method. According to some embodiments of the invention, the process proceeds through the following steps.

At a step 201, a computing device 200 receives a coordinate set 202 of the viewpoint C and a point cloud P 101 via an input channel such as a network socket, an inter-process communication channel or a shared memory segment. Next, the process proceeds to a step 203.

At the step 203, the computing device 200 applies a radial transformation function F_{f}(Pᵢ, C) to each point pᵢ in the point cloud P 101, generating a transformed point set T 204. Next, the process proceeds to a step 205.

At the step 205, the computing device applies, in a differentiable manner, an approximate convex hull filter for each transformed point t in the transformed point set T 204, thereby generating a subset T′ 206 of the transformed point set T. Next, the process proceeds to a step 207.

At the step 207, the process filters the point cloud P 101 according to a filter condition such that each point in the subset 102 corresponds to a point t in the subset T′ 206, thereby generating a directly visible subset of points 102.

This workflow enables direct visibility determination of points in a point cloud without requiring surface reconstruction. The key innovation is the differentiable computation of the convex hull approximation in step 205, enabling the entire process to be optimized end-to-end. The radial transformation in step 203 helps identify potentially visible points by transforming the point cloud P 101 in a way that maps visible points to the convex hull of the transformed set T. The reverse transformation in step 207 maps these transformed points t back to the original point cloud P 101 coordinates to identify the subset of genuinely visible surface points 102.

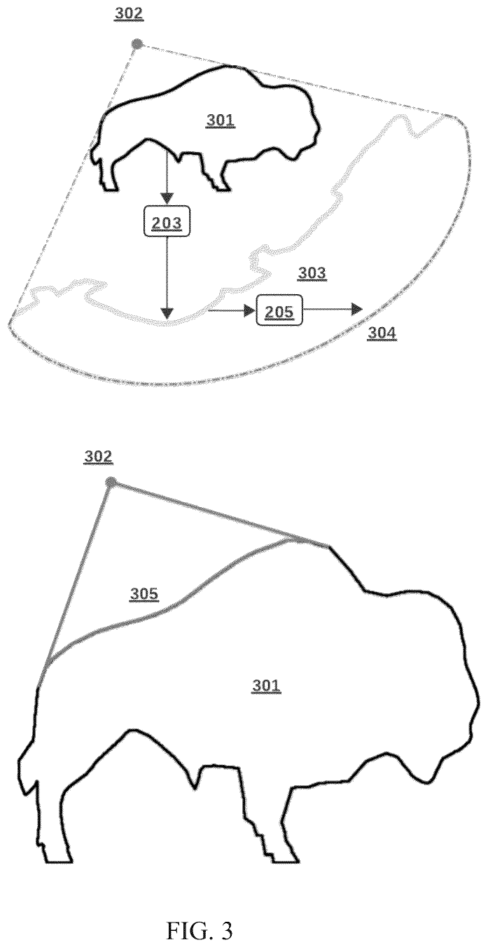

Reference is now made to FIG. 3, illustrating determining the visibility of points in an example 2D contour. According to some embodiments of the invention, a contour P 301 comprises a 2-dimensional point set 101.

Optionally, the process first applies 203 a radial transformation F_{f}(pᵢ, C) to a contour P 301, observed from the initial viewpoint C 302, thereby generating a transformed contour T 303. Next, the process applies 205 a differentiably computed convex hull approximation filter to the transformed contour T 303, thereby computing a convex hull T′ 304.

Next, the process determines a subset of genuinely visible point 305 by filtering the contour 301 based on a correspondence of point p in the original contour P 301 to points comprising the convex hull T′ 304.

Complexity of the present method is O(n²) due to independent visibility computation for each point, computation independence being enabled by independence of visibility computation result for a first point on visibility computation results for other points. However, independent computation allows easy utilization of GPU parallelism, while convex hull construction methods taught by the art (such as QuickHull) are computed on a CPU and are challenging to parallelize for the GPU. Furthermore, computation time of the present method is independent of a specific input and δ value, in contrast to methods known in the art (such as HPR).

For example, processing a same input on an RTX 4090 GPU and an i9-13900K CPU with the present method (HPRO) and a method taught in the art (HPR) requires:
1K points: HPRO 0.3 ms, HPR: 2.1 ms (worst) & 1.7 ms (average);
5K points: HPRO: 3.0 ms, HPR: 9.8 ms (worst) & 5.1 ms (average); and
10K points: HPRO: 11.0 ms, HPR: 19.8 ms (worst) & 8.8 ms (average).

Optionally, filtering the contour 301 comprises performing a reverse conversion of transformed points t comprising the convex hull T′ 304 based on a kernel function.

Optionally, filtering the contour 301 comprises performing an associative search of points p in the contour 301 mapped to respective points t in the convex hull T′ 304.

Optionally, the process outputs for each genuinely visible point 305 a positive visibility indicator if the respective transformed point 305 belongs to the convex hull approximation T′ 304, and a negative visibility indicator otherwise. For example, a visibility indicator of a genuinely visible point 305 may comprise a sign of a number.

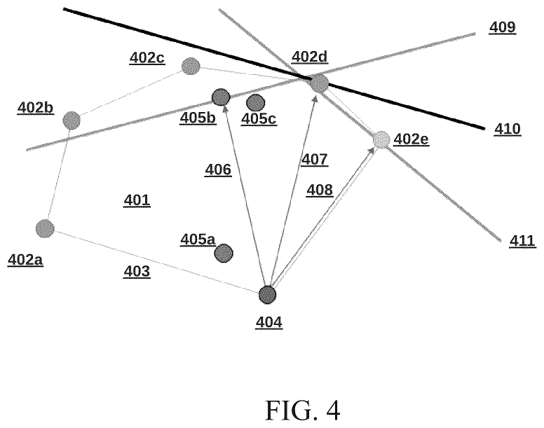

FIG. 4 is a diagram illustrating the process of computing a convex hull approximation in a differentiable manner. According to some embodiments of the invention, a convex hull of a point set P comprises points that are extreme in some direction relative to all other points pᵢ∈P. Therefore, a convex hull approximation may be constructed by examining a condition for each point ∀pᵢ∈P, to determine if it is an extreme point.

Optionally, the method considers a transformed point F(pᵢ, C) an extreme point if it maximizes the projection on a direction

$${d}_{i} = \frac{F ( {p}_{i} , C ) - C}{‖ F ( {p}_{i} , C ) - C ‖} ,$$

wherein a direction dᵢ connects the transformed point F(pᵢ, C) to the viewpoint C.

Optionally, for each point ∀pᵢ∈P, the method computes a visibility indicator Vᵢ in a differentiable manner as follows:
Rᵢⱼ= [symbol] F(pⱼ, C)−C, dᵢ [symbol] , and therefore Rᵢᵢ=∥F(pᵢ, C)−C∥=f_{γ}(∥pᵢ−C∥)

$${V}_{i} = {max}_{j} ( {R}_{ij} ) - {R}_{ii} = 0$$

if pᵢ is an extreme point

$${V}_{i} = {max}_{j} ( {R}_{ij} ) - {R}_{ii} > 0$$

otherwise.

Computing the visibility indicator Vᵢ is differentiable by definition as it solely employs elementary, continuously differentiable operations.

Optionally, an example 2D point cloud P 401 comprises points pᵢ 402a, 402b, 402c, 402d and 402e lying on the true convex hull 403 as completed by a viewpoint C 404, and points pᵢ 405a, 405b, 405c lying inside the convex hull 403. An example vector 406 connects the viewpoint C 404 to a point 405a lying inside the convex hull 403; an example vector 407 connects the viewpoint C 404 to a point 402d lying on the convex hull and correctly identified by the approximate computation as visible, and an example vector 408 connects the viewpoint 404 to a point 402e lying on the true convex 403 hull but incorrectly identified as invisible. Lines 409, 410 and 411 are determined as passing through points 405b, 402d and 402e, respectively, normally to the corresponding vectors 406, 407 and 408.

In the limit, as value of the kernel function parameter approaches zero γ→0⁻, the transformed points t convert to a sphere, and thereby invisible points may be associated with Vᵢ values that are nearly 0. Due to computation inaccuracies inherent in floating-point arithmetic, testing each Vᵢ for being equal to 0 as described hereinabove is impractical. To address this issue, the maximum may instead be computed by normalizing the considered projection lengths by the top projection length value at position k, where k is a predetermined parameter indicating the position of a value in descending order of magnitude, or a top-k function.

Optionally, a visibility score wᵢ of a transformed point F(Pᵢ, C) is determined as:

where

$${w}_{i} = elu ( \frac{{R}_{ii} - {R}_{i , k}}{{R}_{i , m ax} - {R}_{i , k}} ) ,$$

wherein

$${R}_{i , m ax} = {max}_{j} ( {R}_{ij} ) ,$$

R_{i,k} comprises a k-th top value of Rᵢⱼ, i, j ∈[1, n], and elu comprises an Exponential Linear Unit. Therefore,
0≤wᵢ≤1 if Rᵢᵢ comprises one of the top-k values of Rᵢⱼ, i, j ∈[1, n], −1<wᵢ<0 otherwise.

Optionally, R_{i,k} comprises an approximate k-th top value of Rᵢⱼ, i, j ∈[1,n] computed in a differentiable manner.

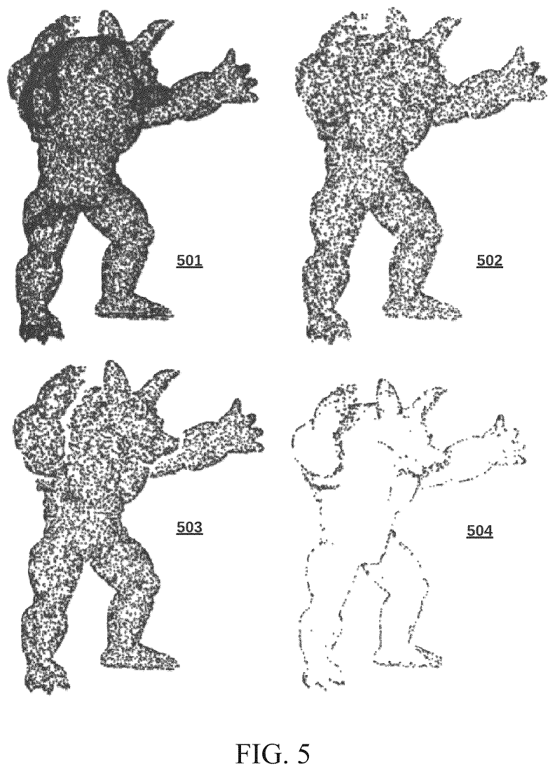

Reference is now made to FIG. 5, illustrating accuracy of the method on a sample input P 501. According to some embodiments of the invention, a ground truth 502 comprises a reference set of points p visible from a chosen point of view C, computed using surface reconstruction, 503 is a subset of points in the sample input P 501 marked as visible by the present method, and 504 is a subset of points in the sample input P 501 that are incorrectly marked as visible or invisible. It is evident that a majority of approximation errors are concentrated around silhouette regions. This implies that relying on a single direction to test for extremity may not always be sufficient for silhouette points, especially for cases when γ is far from a limit Γ. To enhance accuracy, exploring extra directions may be beneficial. This approach is justified by the fact that a point can be considered extreme if it exhibits extremity in at least one direction. Optionally,

$$M = \frac{1}{n} {\sum }_{i = 1}^{n} F ( {p}_{i} , C )$$

comprises a mass of the transformed point set, and C*=αM+(1−α)C comprises a point on a line connecting C and M, wherein α∈[0,1] is a parameter.

Optionally, for each point ∀pᵢ∈P an additional distance metric d* from the auxiliary point C*, a corresponding projection

$${R}_{ij}^{*}$$

and an auxiliary visibility score

$${w}_{ij}^{*}$$

are computed as follows:

$${d}^{*} = \frac{{p}_{i} - {C}^{*}}{‖ {p}_{i} - {C}^{*} ‖}$$

$${R}_{ij}^{*} = 〈 F ( {p}_{j} , C ) - {C}^{*} , {d}_{i}^{*} 〉$$

$${w}_{{i}^{*}} = elu ( \frac{{R}_{ii}^{*} - {R}_{i , k}^{*}}{{R}_{i , m ax}^{*} - {R}_{i , k}^{*}} ) .$$

Optionally, a final visibility score comprises Vᵢ=max(wᵢ, wᵢ^{*}), and a point pᵢ∈P is determined as an extreme point of P if it is extreme in either of the two directions to the viewpoint C and to the auxiliary point C*.

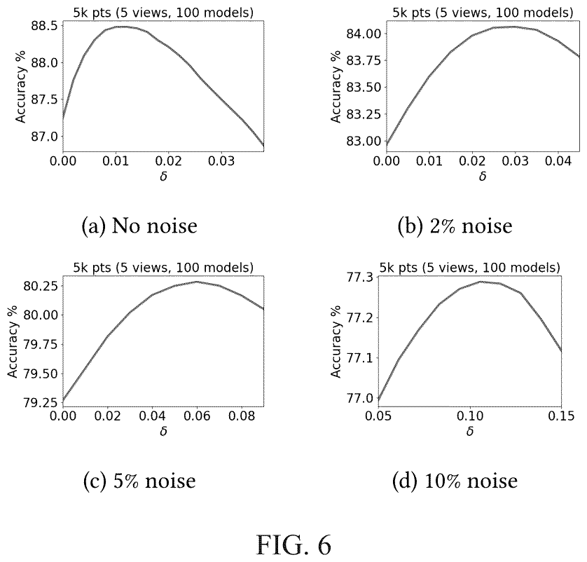

Reference is now made to FIG. 6, illustrating accuracy of the method as a function of a parameter δ for various noise levels in the original point cloud P 101. According to some embodiments of the invention, a point cloud P 101 acquired by a depth measurement device such as a lidar may contain random positioning errors, or noise.

Optionally, for a given noise radius Δ an optimal value comprises δ=Δ+1%. This implies that even in a case when no noise is added, a small value of δ is desirable, as slightly moving a considered point toward the viewpoint C improves the probability of generating a false negative.

Optionally, the method comprises virtually moving a point pᵢ closer to the viewpoint C, potentially enabling the pᵢ being incorrectly determined as invisible due to noise to be correctly determined as visible:
Rᵢᵢ=f₆₅(∥pᵢ−C∥−δ), where the parameter δ<<∥pᵢ−C∥ for ∀pᵢ∈P.
Rᵢᵢ=f_{γ}(∥pᵢ−C∥−δ)^{γ}, where the parameter δ<<∥pᵢ−C∥ for ∀pᵢ∈P.

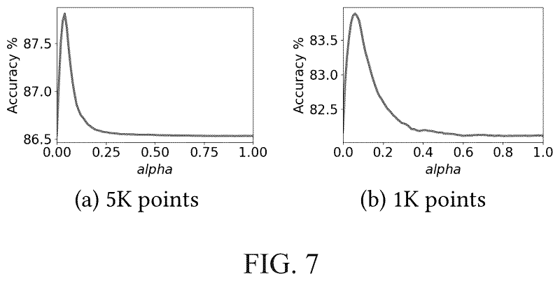

Reference is now made to FIG. 7, illustrating accuracy of the method as a function of a parameter α for various sizes of the point cloud. According to some embodiments of the invention, for denser point sets, γ values that are closer to 0 causing the transformed points to be closer to lying on a sphere display improved performance. Consequently, for more aggressive values of γ the auxiliary point C* should be computed using a lower α value and be closer to the viewpoint C. In the limit, the auxiliary point C* and the viewpoint C coincide, making α=0 the optimal choice.

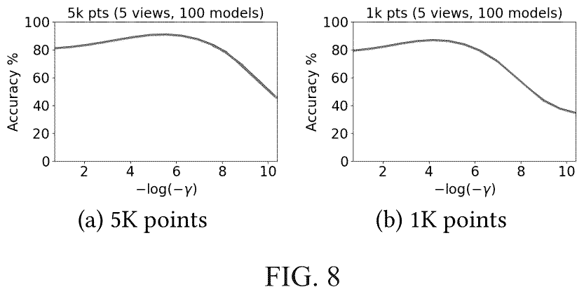

Reference is now made to FIG. 8, illustrating accuracy of the method as a function of a parameter γ for various sizes of the point cloud. According to some embodiments of the invention, the optimal γ is closer to 0, corresponding to a higher −log(−γ). Consequently, to optimize the method's accuracy and mitigate the false negative count, a γ value closer to 0 shall be used, as it better balances between false negatives and false positives.

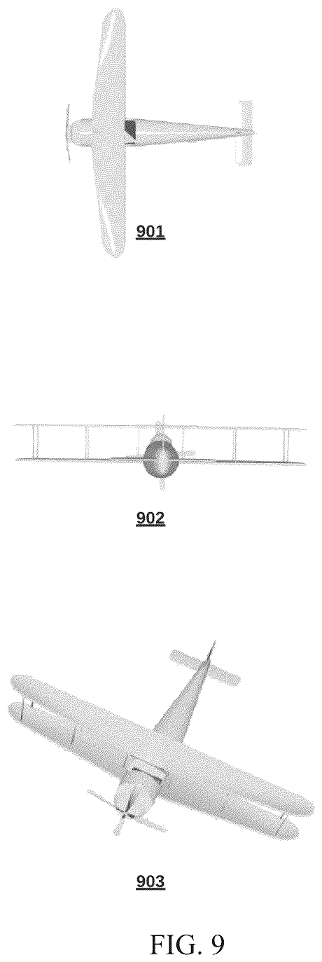

Reference is now made to FIG. 9, illustrating viewpoint optimization performed with the present method. According to some embodiments of the invention, a sample input is rendered from an initial viewpoint 901, an optimized viewpoint providing a minimal view 902, and an optimized viewpoint providing a maximal view 903.

In some embodiments, the method is particularly useful for automated viewpoint selection in computer graphics applications. The method enables efficient exploration and understanding of 3D models by automatically determining optimal viewpoints that maximize information visibility and model comprehension.

The method may be implemented in various applications including, but not limited to, scene navigation systems, scientific visualization platforms, object recognition systems, mesh simplification algorithms, and automated camera placement systems. The method is particularly advantageous in scenarios requiring rapid exploration of large 3D model databases, such as computer game development, computer-aided design, and interior design applications.

Optionally, the method is employed for viewpoint optimization by maximizing a sum of visibility scores to obtain a viewpoint that captures as much of the object comprising the original point cloud as possible.

Optionally, the method is employed for viewpoint optimization by minimizing a sum of visibility scores to obtain a viewpoint that captures as little of the object comprising the original point cloud as possible.

Optionally, the method starts with an initial viewpoint C and employs optimization leveraging differentiability of the computation to achieve a final viewpoint Cₓ, subject to a convergence criterion.

Optionally, a local convergence criterion is satisfied according to at least one of (i) change in visibility score between consecutive iterations falls below a predetermined threshold ϵ, and (ii) a maximum number of iterations is reached. A global convergence criterion is satisfied when the best visibility score across all optimized viewpoints remains unchanged for a predetermined number of iterations.

Optionally, an optimization process aims to minimize or maximize a loss function computed as

$$L = - {\sum }_{i = 1}^{n} {w}_{i} ,$$

wherein wᵢ comprises a visibility score for a point pᵢ, and n is a number of points in an input point cloud P 101 or its sampled subset.

Optionally, the optimization process may be performed one or more times sequentially or in parallel for a plurality of initial viewpoints C, thereby mitigating risks of converging to a viewpoint possessing a local minimum or a local maximum of the loss function.

Optionally, an initial viewpoint C is generated based on random sampling where points are selected with uniform probability from the input point cloud.

Optionally, an initial viewpoint C is generated based on a heuristic method where points are selected based on local point density and geometric feature importance.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for determining the visibility of a point cloud respective to a viewpoint, comprising:
receiving a viewpoint and a point cloud comprising a plurality of points;
computing, for one or more points in the point cloud, respective transformed points using a radial transformation function, thereby generating a plurality of transformed points;
differentiably computing, for the plurality of transformed points, a convex hull approximation; and
outputting, for each of the one or more points in the point cloud and the viewpoint, a visibility indicator.

2. The method according to claim 1,
wherein the radial transformation function maintains direction from the viewpoint to a point in the point cloud as direction from the viewpoint to a respective transformed point, and
wherein the radial transformation function determines distance from the viewpoint to a transformed point based at least in part on distance from the viewpoint to a respective point in the point cloud.

3. The method according to claim 2, wherein the radial transformation function is monotonically decreasing.

4. The method according to claim 2, wherein the radial transformation function comprises a linear inversion kernel.

5. The method according to claim 2, wherein the radial transformation function comprises an exponential inversion kernel.

6. The method according to claim 1, wherein differentiably computing a convex hull approximation comprises:
computing, for the plurality of transformed points, a plurality of respective vector projections from the viewpoint to a transformed point on a vector from the viewpoint to a first transformed point;
determining a transformed point maximizing vector projection on the vector from the viewpoint to the first transformed point; and
outputting, for the first transformed point, a positive indicator if the first transformed point maximizes vector projection on the vector from the viewpoint to the first transformed point, and a negative indicator otherwise.

7. The method according to claim 6, wherein determining a transformed point maximizing vector projection on the vector from the viewpoint to the first transformed point comprises:
determining, using a predetermined normalization function, a top-k projection length value; and
normalizing the plurality of vector projections by the top-k projection length value.

8. The method according to claim 7, wherein determining the top projection length value at position k is performed approximately in a differentiable manner.

9. The method according to claim 7, wherein normalizing a considered projection length utilizing a predetermined normalization function partially comprises computing the output of exponential linear unit.

10. The method according to claim 6, wherein computing a convex hull approximation further comprises:
determining a center of mass of the plurality of transformed points;
selecting an auxiliary point on a line connecting the center of mass of the plurality of transformed points and the viewpoint;
computing, for the plurality of transformed points, a respective plurality of vector projections from the auxiliary point to a transformed point on a vector from the auxiliary point to a first transformed point;
determining a transformed point maximizing vector projection on the vector from the auxiliary point to the first transformed point;
outputting, for the first transformed point, a positive indicator if the first transformed point maximizes at least one of (i) vector projection on the vector from the viewpoint to the first transformed point or (ii) vector projection on the vector from the auxiliary point to the first transformed point, and a negative indicator otherwise.

11. A method for determining an optimal viewpoint placement for a point cloud, comprising:
iteratively performing an optimization process to compute an optimal viewpoint position based on an initial viewpoint position one or more times, the optimization process comprising:
calculating a visibility score gradient with respect to a viewpoint position;
adjusting the viewpoint position in a one of (i) direction of the visibility score gradient, thereby increasing the visibility score, or (ii) in the direction opposite to the visibility score gradient, thereby decreasing the visibility score; and
responsive to meeting a predetermined local convergence criterion, terminating the optimization process, thereby generating the optimal viewpoint position optimizing a total visibility score.

12. The method according to claim 11, further comprising:
performing one of (i) receiving or (ii) generating a plurality of initial viewpoint positions;
for each initial viewpoint position in the plurality of initial viewpoint positions, iteratively performing the optimization process to compute a respective optimal viewpoint position one or more times, thereby generating a plurality of optimal viewpoint positions and a plurality of total visibility scores;
responsive to meeting a global convergence criterion, outputting a globally optimal viewpoint position based at least on the plurality of total visibility scores,
wherein the optimization process further comprises, responsive to meeting the predetermined convergence criterion, storing the optimal viewpoint position and the respective total visibility score.

13. A computer system for determining the visibility of a point cloud respective to a viewpoint, comprising:
a processor configured to execute stored executable instructions; and
a non-transitory computer readable medium storing executable instructions that, when executed by a processor, cause the computer system to perform the following:
receive a viewpoint and a point cloud comprising a plurality of points;
compute, for one or more points in the point cloud, respective transformed points using a radial transformation function, thereby generating a plurality of transformed points;
differentiably compute, for the plurality of transformed points, a convex hull approximation; and
output, for each of the one or more points in the point cloud and the viewpoint, a visibility indicator.
